(19) United States
(12) Patent Application Publication
(10) Pub. No.: US 2021/0398150 A1
(43) Pub. Date: Dec. 23, 2021

(54) METHOD AND COMPUTER NETWORK FOR GATHERING EVALUATION INFORMATION FROM USERS

(71) Applicant: SQN INNOVATION HUB AG, ZUERICH (CH)

(72) Inventors: ADAM VOTAVA, STARE MESTO (CZ); PER LAGERSTROM, ST. SUPLICE (CH); KATHRYN FORGAN, ST. SULPICE (CH)

(21) Appl. No.: 16/629,459

(22) PCT Filed: Jun. 24, 2019
(86) PCT No.: PCT/EP2019/066723

§ 371 Date: Jan. 8, 2020

(51) Int. Cl. G06Q 30/02

(52) U.S. Cl. CPC G06Q 30/0203; G06Q 30/0201

(57) ABSTRACT

A method for generating an adjusted set of response tasks based on a freely formulated response of a user includes using a computer network to receive an initial set of predetermined response tasks, each response task including predetermined response options, based on the selected response options, evaluation information for evaluating at least one predetermined characteristic can be determined, outputting, using a computer device of the computer network, at least one free-formulation response task to at least one user through which an at least partially freely formulated response can be received from the user, identifying, using a computer device, evaluation information based on the freely formulated response, the evaluation information usable for evaluating the predetermined characteristic, and generating, using a computer device, an adjusted set of response tasks based on the identified evaluation information. A computer network gathering evaluation information for a predetermined characteristic from a user is also provided.

The invention concerns a method and a computer network for gathering evaluation information from users.

It is known to use computer networks for gathering responses from users of said computer networks. Typical examples are online surveys or online questionnaires. These user responses may represent and/or contain evaluation information for evaluating a characteristic of interest. Using computer networks provides the advantage of a high or even full level of automation, thus e.g. allowing to deal with very high number of users in limited time and with limited organisational efforts.

A use case to which this invention is specifically directed is the gathering of responses from members of large organisations, such as employees of a company, e.g. via an online survey or online questionnaire. This may be employed to perform a performance analysis or leadership analysis of the company and/or to determine a level of employee satisfaction.

Existing solutions, however, suffer from several drawbacks. For example, in order to evaluate characteristics of interests in a sufficiently precise and reliable manner, a large number of responses may have to be provided by each user. For example, for receiving statistically significant results, many similar and/or related questions may have to be posed to the same user which more or less concern the same topic. This may be perceived as lengthy and inefficient.

Importantly, however, this increases the time required for conduction online surveys. Also, this increases the overall amount of data that have to be exchanged between computer devices involved in the survey. The latter may result in a need for respectively large communication bandwidths and communication volumes, this being particularly undesired for mobile computer devices, such as smartphones. Likewise, this increases the number of data having to be analysed and/or computed, thus requiring respectively large computational capabilities, data storage means and/or respectively large computation times.

An object of the present invention is thus to improve existing ways of using computer networks for gathering responses from users (e.g. via online surveys), in particular with regard to reducing the time and effort for conducting the response (i.e. data) gathering and/or for analysing the received responses (i.e. data). Generally, the solutions disclosed herein may be directed to alleviating any of the above-mentioned drawbacks.

This object is solved by a method and a computer network according to the attached independent claims. Advantageous embodiments are defined in the dependent claims.

According to a basic idea of this disclosure, much like in existing solutions, an initial set of predetermined response tasks may be received (e.g. a predetermined list of questions). Yet, instead of the user having to work himself through all of these response tasks, this initial set of response tasks may be adjusted and in particular reduced. This reduces both the burden from the user's as well as from a general computational perspective. This way, an adjusted set of response tasks may be generated.

Generally, the response tasks of the initial set may be referred to as structured response tasks, since they may comprise predetermined response options as is known from standard online surveys. As discussed below, they may also produce structured (response) data, that e.g. directly have a desired processable format. Such response options typically allow the user to provide his response to a response task by performing selections, scalings, weightings, typing in numbers or text or by performing similar inputs of an expected type and/or from an expected range.

Yet, according to the disclosed solution, as a preferably first response task, a free-formulation response task may be output to a user (and preferably to a number of users). This task may, contrary to the initial set of response tasks, be free of any predetermined response options (i.e. may be unstructured and/or produce unstructured (response) data as discussed below that typically represent unprocessable raw data). Instead, the free-formulation response task may be answered or, differently put, may be completed by a freely formulated input of the user (e.g. speech or text or an observed behavior e.g. during interaction with an augmented reality (AR) system). An example would be to ask the user for his opinion on, his understanding of or a general comment on a certain topic. The user may then e.g. write or say an answer and this may be recorded and/or gathered by the computer network.

Following that, e.g. by way of a software-based computerised analysis, the user's freely formulated response may be analysed. Specifically, information that are usable for evaluating at least one characteristic of interest (preferably one that is also to be evaluated by the initial set of response tasks) may be identified from the freely formulated response. As will be detailed below, this may be done by respectively configured computer algorithms or software modules. For example, it may be identified whether a user speaks positively or negatively about a certain characteristic of interest and/or which significance the user assigns to certain characteristics. Such information may be translated into an evaluation score for said characteristic.

Thus, the analysis of the freely formulated response may include steps of identifying which characteristics are concerned by the freely formulated response and/or how this characteristic is evaluated by the user (positive, negative, important, not important etc.).

The freely formulated response may represent unstructured data. According to standard definitions, such unstructured data do not comply with a specific structure or format (e.g. desired arrays or matrices) that would enable them to be analysed in a desired manner (e.g. by a given algorithm or computer model). They may thus represent raw data that is unprocessable e.g. for a standard evaluation algorithm of an online survey that is only configured to deal with selections from predetermined response tasks. Accordingly, the present solution may include dedicated analysis tools (e.g. computer models) for extracting evaluation information for such unstructured data. To the contrary, evaluation information determined via the predetermined response tasks may be structured since they already comply with a desired format or structure (e.g. in form of arrays comprising selected predetermined response options).

To sum up, the freely formulated response may be analysed to determine, whether the user has already provided at least some or even sufficient evaluation information for at least one characteristic that should also be evaluated by the initial set of response tasks. If that is the case, the initial set of response tasks may be adjusted accordingly and/or a generally new adjusted set of response tasks may be generated. Again, this adjusted set of response task may include predetermined response task with predetermined response options but, as noted above, the number of said response tasks and/or response options may be different from the initial set and may in particular be reduced.

This way, the number of predetermined response tasks that the user has to answer in a subsequent stage (i.e. when answering the adjusted set) can be reduced. This, in turn, also means that the amount of generated data having to be stored, processed or communicated can be reduced at least in said subsequent stages. This allows for a faster and more efficient operation of the overall computer network, e.g. since the online survey generally occupies the computer network for a shorter time period and/or uses less resources thereof.

This may be particularly valid when, according to an embodiment of the invention, analysing tools for the freely formulated response (e.g. models and/or algorithm) and/or adjustment tools for the initial set of response tasks are directly stored on user devices. This way, the freely formulated response of a user does not have to be communicated to a remote analysing tool (much like no analyses results have to communicated back from said tool) which further limits the solution's impact on and resource usage of the overall computer network.

Specifically, a method for gathering evaluation information from a user with a computer network is suggested, the computer network performing the following, i.e. performing the following method steps:
receiving an initial set of predetermined response tasks, each response task including a number of predetermined (e.g. user-selectable) response options (e.g. in form of a predetermined input option), wherein based on the response options selected by a user, evaluation information for evaluating at least one predetermined characteristic are determined (or, differently put, gathered);
outputting, via a computer device of said computer network, at least one free-formulation response task to the user by means of which an at least partially freely formulated response can be received from the user;
identifying (e.g. by a computerised analysis), via a computer device of said computer network, evaluation information based on the freely formulated response, said evaluation information being usable for evaluating the at least one predetermined characteristic;
(preferably automatically) generating, via a computer device of said computer network, an adjusted set of predetermined response tasks based on the identified evaluation information; and preferably
outputting the adjusted set of predetermined response tasks to the user.

Preferably, a large number of users is dealt with e.g. by outputting a free-formulation response task and/or the adjusted set to several hundred users. The analysis may then equally focus on all of the freely formulated responses and the adjusted set may be generated based on the identified evaluation information (particularly evaluation scores) received from all of the users.

If in the following referring to a user, it is to be understood that this may be one out of a plurality of users and that each of the further users may be addressed and/or interacted with in a similar manner.

As will be detailed below, the computer network and in particular at least one computer device thereof (e.g. the central computer device discussed below) may comprise at least one processing unit (e.g. including at least one microprocessor) and/or at least one data storage unit. The data storage unit may contain program instructions, such as algorithms or software modules. The processing unit may use these stored program instructions to execute them, thereby performing the steps and/or functions of the method disclosed herein. Accordingly, the method may be implemented by executing at least one software program with at least one processing unit of the computer network.

The computer network may be and/or comprise a number of distributed computer devices. Accordingly, the computer network may comprise a number of computer devices which are connected or connectable to one another, e.g. for exchanging data therebetween. This connection may be formed by wire-bound or wireless communication links and, in particular, by an internet connection.

For performing the method, users may access an online platform by user-bound computer devices of the computer network. The online platform may be provided by a server of the computer network. The server may optionally be connected to a central computer device which e.g. performs the identification/analysis of freely formulated responses and/or includes the computer model discussed below. Additionally or alternatively, the central computer device may adjust the set of response tasks. The server may then receive this adjusted set and output it to the user(s).

As a general aspect, any of the functions discussed herein with respect to a central computer device may also be provided by user-bound devices that a user directly interacts with. This particularly relates to analysing the freely formulated response, e.g. due to storing a respective model as discussed below directly on user-bound devices. Such a model may e.g. be included in a software application that is downloaded to said user-bound devices. The analysis result may then be communicated to the central computer device. On the other hand, the user-bound devices may directly use these analysis results to perform any of the adjustments of the initial set of response task discussed herein. Preferably, however, responses to the adjusted set of response tasks are provided to a central computer device which preferably analyses responses received from a large number of users in a centralised manner.

By shifting functions to user-bound devices, resource usage of the computer network and in particular a communication network comprised thereby can be reduced. Additionally or alternatively, the general reaction time and thus interaction speed with a user can be increased due to a reduced risk of delays that might occur when frequently communicating back and forth with a central computer device.

The term “central” with respect to the central computer device may be understood in a functional or hierarchical manner, but not necessarily in a geographical manner. As noted above, as respective centralised functions the central computer device may define or forward the initial set of predetermined response tasks and/or may analyse the free-formulation response task and/or may adjust the set of predetermined response tasks. It may output the initial and/or adjusted response tasks to user-bound computer devices or to a server connected to said user-bound computer devices. The user-bound computer devices may be mobile end devices, smartphones, tablets or personal computers. User-bound computer devices may be computer devices which are under direct user control, e.g. by directly receiving inputs from the user via dedicated input means.

Also, the central computing unit may receive e.g. the freely formulated responses from said user-bound computer devices. The user-bound computer devices and the central computer device may thus define at least part of the computer network. Yet, they may be located remotely from one another.

The user-bound computer devices may, for performing the solution disclosed herein, e.g. access or connect to a webpage and/or a software program that is run on the central computer device and/or to a server, thereby e.g. accessing the online platform discussed herein. Such accesses may enable the data exchanges between the computer devices discussed herein.

When being connected to a communication network and in particular to the online platform, a computer device may be referred to as being online and/or a data exchange of said computer device may be referred to as taking place in an online manner. The communication links may be part of a communication network. They may be or comprise a WLAN communication network. In general, the communication network may be internet-based and/or enable a communication between at least the (user-bound) computer devices and a central computer device via the internet.

The central computer device may be located remotely from the organisation and may e.g. be associated with a service provider, such as a consultancy, that has been appointed to gather the evaluation information.

The response tasks of the initial set may be predetermined in that they should theoretically be provided to a user in full (i.e. as a complete set) and/or in that their contents and/or response options are predetermined. The response tasks may be datasets or may be part of a dataset. A response task can equally be referred to as a feedback task prompting a user to provide feedback.

For example, each response task may comprise text information (e.g. text data) formulating a task for prompting the user to provide a response. For example, the text information may ask the user a distinct question and/or may prompt the user to provide a feedback on a certain topic. The response may then be provided by the user selecting one of the predetermined (i.e. available and prefixed) response options.

Accordingly, the response options may be selectable response options, the selection being performed e.g. based on a user input. For example, each response task may be associated with at least two response options and a response to the response task may the defined by the user selecting one of these response options.

The response options may be selectable values along a scale (e.g. a numeric scale). Each selectable value along said scale may represent a single response option. Likewise, the response options may be numbers, words or letters that can be entered into e.g. a text field and/or by using a keyboard. However, an inputted text may only be valid and accepted as a response if it conforms to an expected (e.g. valid) response option that may be stored in a database. Thus, the overall response options may again be limited and/or pre-structured or predetermined.

Additionally or alternatively, the response options may be statements or options that the user can select as a response to a response task. Additionally or alternatively, absolute question types may be included in which a respondent directly evaluates a certain aspect e.g. by quantifying it and/or setting a (perceived) level thereof. A response option may then be represented by each level that can be set or each value that can be provided as a quantification.

For example, a response task may ask a user to select one out of a plurality of options as the most important one, wherein each option is labeled by and/or described as a text. The response options may then be represented by each option and/or label that can be selected (e.g. by a mouse click).

An advantage of providing predetermined response options is that the subsequent data analysis can be comparatively simple. For example, each response option may be directly associated or linked with a value of an evaluation score. Thus, when being selected, said score can be directly derived without extensive analyses or computations.

On the other hand, a disadvantage may be seen in that for evaluating each characteristic of interest, dedicated response tasks along with dedicated response options have to be provided for each respective characteristic. As previously noted, this may lead to long and data-intensive procedures, in particular when trying to achieve statistically significant results.

To the contrary, the solution disclosed herein may help to limit the number of dedicated response tasks and response options by, as a preferably initial measure, using the freely formulated response to cancel out those response tasks and/or response options associated with characteristics of interests for which sufficient information have already been provided by said freely formulated response.

A response task may generally be output in form of audio signals, as visual signals/information (e.g. via at least one computer screen) and/or as text information.

The characteristic of interest may be a certain aspect, such as a characteristic of an organisation. For example, the characteristic may be a predetermined mindset or behavior that is observable within the organisation. The evaluation may relate to the importance and/or presence of said mindset or behavior within the organisation from the employees' perspective. Thus, the method may be directed at generating evaluation scores for each mindset or behavior from the employees' perspective to e.g. determine which of the mindsets and behaviors are sufficiently present within the organisation and which should be further improved and encouraged.

Identifying the evaluation information may include analysing the freely formulated response or any information derived therefrom. For example, the freely formulated response may be at first provided in form of a speech input and/or audio recording which may then be converted into a text. Both, the original input as well as a conversion (in particular into text) may in the context of this disclosure be considered as examples of a freely formulated response. For this conversion, known speech-to-text algorithms can be employed. The text can then be analysed to identify the evaluation information.

The identification may include identifying keywords, keyword combinations and/or key phrases within the freely formulated response. For doing so, comparisons of the freely formulated response to prestored information and in particular to prestored keywords, keyword combinations or key phrases as e.g. gathered from a database may be performed. Said prestored information may be associated or, differently put, linked with at least one characteristic to be evaluated (and in particular with evaluation scores thereof), this association/link being preferably prestored as well.

Additionally or alternatively, a computer model and in particular a machine learning model may be used which may preferably comprise an artificial neural network. This will be discussed in further detail below. This computer model may model an input-output-relation, e.g. defining how contents of the freely formulated response and/or determined meanings thereof translate into evaluation scores for characteristics of interest.

Also, the identification of evaluation information from the freely formulated response may include at least partially analysing a semantic content of the freely formulated response and/or an overall context of said response in which e.g. an identified meaning or key phrase is detected. Again, this may be performed based on known speech/text analysis algorithms and/or with help of the computer model.

Specifically, the above-mentioned computer model and in particular machine learning model may be used for this purpose. Said model may receive the freely formulated response or at least words or word combinations thereof as input parameters and may e.g. output an identified meaning and/or identified evaluation information. In a known manner, it may also receive n-grams and/or outputs of so-called Word2Vec algorithms as an input. Generally put, the model may receive analysis results of the freely formulated response (e.g. identified meanings) determined by known analysis algorithms and use those as inputs or may include such algorithms for computing respective inputs. The model may (e.g. based on verified training data) define, how such inputs (i.e. specific values thereof) are linked to evaluation information.

As an example, the model may e.g. be determined whether an identified keyword is mentioned in a positive or negative context. This may be employed to evaluate the associated characteristic accordingly, e.g. by setting an evaluation score for said characteristic to a respectively high or low value.

In this context, employing a computer model and in particular machine learning model may have the further advantage of an identified context and/a semantic content being converted into respective evaluation scores in a more precise and in particular more refined manner compared to performing one-by-one keyword comparisons with a prestored database.

For example, the computer model may be able to model and/or define more complex or more (non-linear) interrelations between contents of the freely formulated response and the evaluation scores for characteristics of interests. This may relate in particular to determining, whether a certain keyword or keyword combination is mentioned in a positive or negative manner within said response. For example, the model may be able to also consider that the presence of further other keywords within said response may indicate a positive or negative context.

For such a computer model, no comparisons to prestored information which exactly describe the above relations may have to be provided, but the model may include or define (e.g. mathematical) links, rules, associations or the like that have e.g. been trained and defined during a machine learning process. In consequence, even if keyword combinations are provided that are as such unknown to the model (i.e. have not been part of a training dataset and are not contained in any prestored information), the model may still be able to compute a resulting evaluation score due to the general links and/or mathematical relations defined therein.

In general, for evaluating a characteristic, several responses and/or selections of response options may have to be gathered from each user, each producing evaluation information for evaluating said characteristic. That is, a plurality of response tasks may be provided that are directed to evaluating the same characteristic.

An evaluation and in particular an evaluation information may represent and/or include a score or a value, such as an evaluation score discussed herein. The total amount and/or number of evaluation information (e.g. the total amount of selections) from one user and preferably from a number of users may then be used to determine a final overall evaluation of said characteristic. For example, a mean value of evaluation scores gathered via various response tasks and/or response options from one or more user(s) may be computed. In this context, the evaluation scores may each represent one evaluation information and are preferably directed to evaluating the same characteristic. On the other hand, at least on a single user level it may equally be possible to only provide one evaluation information and/or one evaluation score for each characteristic to be evaluated. An overall evaluation score for the characteristic may then be computed based on said single evaluation information derived from each of a number of users.

The adjustment of the set of predetermined response tasks may be performed at least partially automatic but preferably fully automatic. For doing so, a computer device of the computer network and in particular the central computer device may perform the respective adjustment based on the result of the identification or, more generally, based on the analysis result of the freely formulated response.

For doing so, it may be determined for which characteristics evaluation information have already been gathered via said freely formulated response. Differently put, it may be determined which characteristic has already been at least partially, sufficiently and/or fully evaluated with said evaluation information. For example, it may be determined whether sufficient evaluation information have been gathered from a statistical point of view to, e.g. with a desired statistical certainty, evaluate the characteristic of interest.

Then, it may be determined which response tasks (e.g. of the initial set of predetermined response tasks) and/or which response options of said response tasks are directed to gathering evaluation information for the same purpose and in particular for evaluating the same characteristic. If it has been determined that sufficient evaluation information for said characteristic have been gathered (e.g. a minimum amount of evaluation scores), response tasks and/or response options included in said initial set may be removed from the initial set and/or may not be included in the adjusted set.

Thus, it may be avoided that more evaluation information than actually needed are gathered. This renders the overall method more efficient and e.g. limits the data amount to be communicated and/or processed within the computer network.

Accordingly, the preferably automatic adjustment may include the above discussed automatic determination of removable or, differently put, omissible response tasks and/or response options. Also, this adjustment may include the respective automatic removal or omission as such.

Outputting the adjusted set of predetermined response tasks may include communicating the adjusted set from e.g. a central computer device to user-bound computer devices of the computer network. Thus, the adjusted set of response tasks may generally be output by at least one computer device of said computer network. Again, this set may be output via at least one computer screen of said user-bound computer device. The adjusted set of predetermined responses may then be answered by the user similar to known online surveys and/or online questionnaires. This way, any missing evaluation information that have not been identified from the freely formulated response may be gathered for evaluating the one or more characteristics of interest.

As previously mentioned, the freely formulated response may be a text response and/or a speech response and/or a behavioral characteristics of the respondent, e.g. when providing the speech or text response or when interacting with an augmented reality scenario. The computer device may thus include a microphone and/or a text input device and/or a camera. It may also be possible that a speech input is directly converted into a text e.g. by a user-bound computer device and that the user may then complete or correct this text which then makes up the freely formulated response. This is an example of a combined text-and-speech-response which may represent the freely formulated response.

In one embodiment, the freely formulated response may at least partially be based on or provided alongside with an observed behavior, e.g. in an augmented reality environment. For example, the user may be asked to provide a response by engaging in an augmented reality scenario that may e.g. simulate a situation of interest (e.g. interacting with a client, a superior or a team of colleagues). Responses may be given in form of and/or may be accompanied with actions of the user. Said actions may be marked by certain behavioral patterns and/or behavioral characteristics which may be detected by a computer device of the computer network (e.g. with help of camera data). Such detections may serve as additional information accompanying e.g. speech information as part of the freely formulated response or may represent at least part of said response as such. They may e.g. be used as input parameters of a model to determine evaluation information. Behavioral characteristics may e.g. be a location of a user, a body posture, a gesture or a velocity e.g. of reacting to certain events.

Moreover, as previously mentioned, the free-formulation response task may ask and/or prompt the user to provide feedback on a certain topic. This topic may be the characteristic to be evaluated.

As likewise mentioned, according to an embodiment, generating the adjusted set may include adjusting the initial set of predetermined response tasks, e.g. by reducing the number of response tasks and/or response options. In this context, those response tasks and/or response options may be removed which are provided to gather evaluation information which have already been identified based on the freely formulated text response.

Additionally or alternatively, adjusting the set of predetermined response task may include selecting certain of the response tasks from an initial set and making up (or, differently put, composing) the adjusted set of predetermined response tasks based thereon. Generally, it is also conceivable to adjust the set of predetermined response tasks by defining a sequence of the response tasks according to which these are output to the user. Response tasks directed to gathering evaluation information which have been derived from the freely formulated response may be placed in earlier positions according to said sequence. This may increase the quality of the received results since users tend to be more focused during early stages of e.g. an online survey.

Generally, any of the following adjustments or reactions to the freely formulated response and in particular to its analysed contents (alone or in any combination) are conceivable, apart from the ones mentioned above:
In case the freely formulated response contains evaluation information for a characteristic of interest, response tasks directed to said characteristic may be omitted;
In case the freely formulated response contains information not related to any characteristic of interest, this may be signaled to e.g. a system administrator. Such information may represent a new topic. In case similar new topics occur throughout a larger number of freely formulated responses from a number of users, this may prompt the system administrator to include predetermined response tasks specifically directed to said topic/characteristic;
In case the freely formulated response contains evaluation information for a characteristic of interest, response tasks related to similar characteristics may be output first in a subsequent stage. Differently put, a need for providing certain follow-up question may be determined which focus on the same or a related topic/characteristic.

In one development, the identification of evaluation information based on the freely formulated response (e.g. the analysis of said freely formulated response) is performed with a computer model that has been generated (e.g. trained) based on machine learning. In general, for generating the computer model a supervised machine learning task may be performed and/or a supervised regression model may be developed as the computer model. Generating the model may be part of the present solution and may in particular represent a dedicated method step. From the type or class and in particular the program code, a skilled person can determine whether such a model has been generated based on machine learning. Note that generating a machine learning model may include and/or may be equivalent to training the model based on training data until a desired characteristic thereof (e.g. a prediction accuracy) is achieved.

Generally, the model may be computer implemented and thus may be referred to as a computer model herein. It may be included in or define a software module and/or an algorithm in order to, based on the freely formulated response, determine evaluation information contained therein or associated therewith. Generating the model may be part of the disclosed solution. Yet, it may also be possible to use a previously trained and/or generated model.

The model may, e.g. based on a provided training dataset, express a relation or link between contents of the freely formulated response and evaluation information and/or at least one characteristic to be evaluated. It may thus define a preferably non-linear input-output-relation in terms of how the freely formulated response at an input side translates e.g. into evaluation information and in particular evaluation scores for one or more characteristics at an output side.

The training dataset may include freely formulated responses e.g. gathered during personal interviews. Also, the training dataset may include evaluation information that have e.g. been manually determined by experts from said freely formulated responses. Thus, the training dataset may act as an example or reference on how freely formulated responses translate into evaluation information. This may be used to, by machine learning processes, define the links and/or relations within the computer model for describing the input-output-relation represented by said model.

Specifically, the model may define weighted links and relations between input information and output information. In the context of a machine learning process, these links may be set (e.g. by defining which input information are linked to which output information). Also, the weights of these links may be set. In a generally known manner, the model may include a plurality of nodes or layers in between an input side and an output side, these layers or nodes being linked to one another. Thus, the number of links and their weights can be relatively high, which, in turn, increases the precision by which the model models the respective input-output-relation.

The machine learning process may be a so-called deep learning or hierarchical learning process, wherein it is assumed that numerous layers or stages exist according to which input parameters impact output parameters. As part of the machine learning process, links or connections between said layers or stages as well as their significance (i.e. weights) can be identified.

Similarly, a neural network representing or being comprised by a computer model and which may result from a machine learning process according to any of the above examples, may be a deep neural network including numerous intermediate layers or stages. Note that these layers or stages may also be referred to as hidden layers or stages, which connect an input side to an output side of the model, in particular to perform a non-linear input data processing. During a machine learning process, the relations or links between such layers and stages can be learned or, differently put, trained and/or tested according to known standard procedures. As an alternative to neural networks, other machine learning techniques could be used.

Thus, as mentioned, the computer model may be an artificial neural network (also only referred to as neural network herein). The machine learning process may be a so-called deep learning or hierarchical learning process, wherein it is assumed that numerous layers or stages exist according to which input information impact output information. As part of the machine learning process, links or connections between said layers or stages as well as their significance (i.e. weights) might be identified.

In sum, according to a further embodiment, the computer model determines and/or defines a relation between contents of the freely formulated response and evaluation information for the at least one characteristic. Thus, based on the freely formulated response the model may compute respective evaluation information and in particular an evaluation score for said characteristic. On the other hand, it may also determine that no evaluation information of a certain type or for certain characteristic are contained in the freely formulated response. This may be indicated by setting an evaluation score for said characteristic to a respective predetermined value (e.g. zero).

According to one embodiment, by means of the computer model, an evaluation score is computed, indicating how the characteristic is evaluated. The evaluation score may be positive or negative. Alternatively, it may be defined along an e.g. only positive scale wherein the absolute value along said scale indicates whether a positive or negative evaluation is present (e.g. above a certain threshold, such as 50, the evaluation score may be defined as being positive). Alternatively, the evaluation score may indicate a certain level (e.g. a level of importance, a level of a characteristic being perceived to be present/established, a level of a statement being considered to be true or false, and so on). By means of the evaluation score and in particular the model directly determining and outputting such an evaluation score, the analysis of the gathered responses can be conducted efficiently and reliably.

Moreover, a confidence score may be computed by means of the computer model, said confidence score indicating a confidence level of the computed evaluation score. The confidence score may be determined e.g. by the model itself. For example, the model may e.g. depending on the weights of links and/or confidence information associated with certain links determine, whether a input-output relation and that the resulting evaluation score is based on a sufficient level of confidence and e.g. based on a sufficient amount of considered training data. Evaluation scores that have been determined by means of links with comparatively low weights may receive lower confidence scores than evaluation scores that have been determined by means of high-weighted links.

Additionally or alternatively, known techniques for how machine learning models evaluate their predictions in terms of an expected accuracy (i.e. confidence) may be used to determine a confidence score. For example, a probabilistic classification may be employed and/or an analysed freely formulated response (or inputs derived therefrom) may be slightly altered and again provided to the model. In the latter case, if the model outputs a similar prediction/evaluation information, the confidence may be respectively high. Thus, the confidence score may be determined based on the output of a computer model which is repeatedly provided with slightly altered inputs derived from the same freely formulated response.

Additionally or alternatively, the confidence score may be determined based on the length of a received response (the longer, the more confident), based on identified meanings and/or semantic contents of a received response, in particular when relating to the certainty of a statement (e.g. “It is . . . ” being more certain than “I believe it is . . . ”), and/or based on a consistency of information within a user's response. For example, in case the user provides contradicting statements within his response, the confidence score may be set to a respectively lower value.

Generally, when using a computer model for analysing the freely formulated response, said computer model may have been trained based on training data. These data may be historic data indicating actually observed and/or verified relations between freely formulated responses and evaluation information contained therein. This may result in the confidence score being higher, the higher the similarity of a freely formulated response to said historic data.

According to a further example and as mentioned above, the computer model may comprise an artificial neural network.

In a further aspect, a completeness score may be computed (e.g. by a computer device of the computer network and in particular a central computer device thereof), said completeness score indicating a level of completeness of the gathered evaluation information, e.g. compared to a desired completeness level. The completeness score may indicate whether or not a sufficient amount or number of evaluation information and e.g. evaluation scores have been gathered for evaluating at least one characteristic of interest. Preferably, for each characteristic, a respective completeness score may be gathered.

Also, it may indicate whether a desired statistical level and in particular statistical certainty has been achieved, e.g. based on a distribution of the evaluation scores received so far for evaluating a certain characteristic. That is, a statistic confidence level may be determined with regard to the distribution of all evaluation scores for evaluating a certain characteristic.

The confidence level may be different from the confidence score noted above which describes a confidence with regard to the input-output-relation determined by the model (i.e. an accuracy of an identification performed thereby). Specifically, this confidence level may describe a confidence level in terms of a statistical significance and/or statistic reliability of a determined overall evaluation of the at least one characteristic of interest.

For doing so, it is preferred to consider the evaluation information received for said characteristic from all users and, differently put, across all respondents. These evaluation information may then define a statistical distribution (of e.g. evaluation scores for said characteristic) and this distribution may be analysed in statistical terms to determine the completeness score. For example, if said distribution indicates a standard deviation below of an acceptable threshold, the completeness may be set to a respectively low and in particular to an acceptable value.

Additionally or alternatively, the completeness score may be calculated across a population of respondents. It may indicate the degree to which a certain topic and in particular a characteristic of interest has already been covered by said respondents. If the completeness score is above a desired threshold, it may be determined that further respondents may not have to answer response tasks directed to the same or a similar characteristic. The free formulation response task and/or initial set of response tasks for these further respondents may be adjusted accordingly upfront.

The invention also relates to a computer network for gathering evaluation information for at least one predetermined characteristic from preferably a plurality of users,

wherein the computer network has (e.g. by accessing, storing and/or defining it) an initial set of predetermined response tasks, each response task comprising a number of predetermined response options, wherein based on the response options selected by a user, evaluation information for evaluating at least one predetermined characteristic are gathered or determined;

wherein the computer network comprises at least one processing unit that is configured to execute the following software modules, stored in a data storage unit of the computer network:
a free-formulation output software module that is configured to provide, generate and/or output at least one free-formulation response task by means of which a freely formulated response can be received from at least one user, preferably wherein said pre-formulation response task does not include predetermined response options;
a free-formulation analysis software module that is configured to analyse the freely formulated response and to thereby identify evaluation information contained therein, said evaluation information being usable for evaluating the at least one predetermined characteristic;
a response set adjusting software module is configured generate an adjusted set of response tasks based on the evaluation information identified by the free-formulation analysis software module.

A software module may be equivalent to a software component, software unit or software application. The software modules may be comprised by one software program that is e.g. run on the processing unit. Generally, at least some and preferably each of the above software modules may be executed by a processing unit of a central computer devices discussed herein. Also, any further software modules may be included for providing any of method steps disclosed herein and/or for providing any of the functions or interactions of said method.

For example, a free-formulation gathering software module may be provided which is configured to gather a freely formulated response in reaction to the free-formulation response task. This software module may be executed by a user-bound computer device and may then communicate the freely formulated response to e.g. the free-formulation analysis software module.

Generally, the computer network may be configured to perform any of the steps and to provide any functions and/or interactions according to any of the above and below aspects and in particular according to any of the method aspects disclosed herein. Thus, the computer network may be configured to perform a method according to any embodiment of this invention. For doing so, it may provide any further features, further software modules or further functional units needed to e.g. perform any of the method steps disclosed herein. Also, any of the above and below discussions and explanations of method-features and in particular their developments or variants may equally apply to the similar features of the computer network.

The invention will be further discussed with respect to the attached schematic drawings. Similar features may be labeled with similar reference signs throughout the figures.

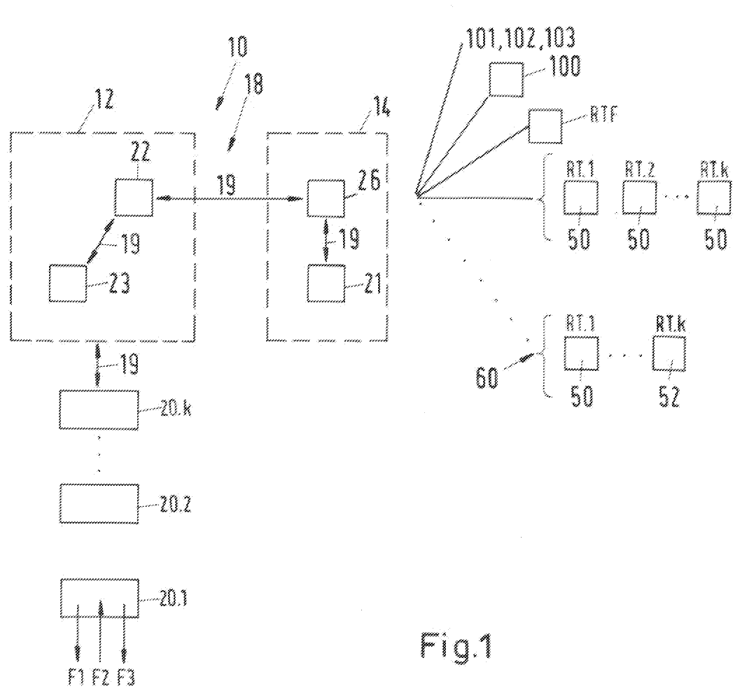

FIG. 1 shows an embodiment of a computer network according to the invention, the computer network performing a method according to an embodiment of the invention;

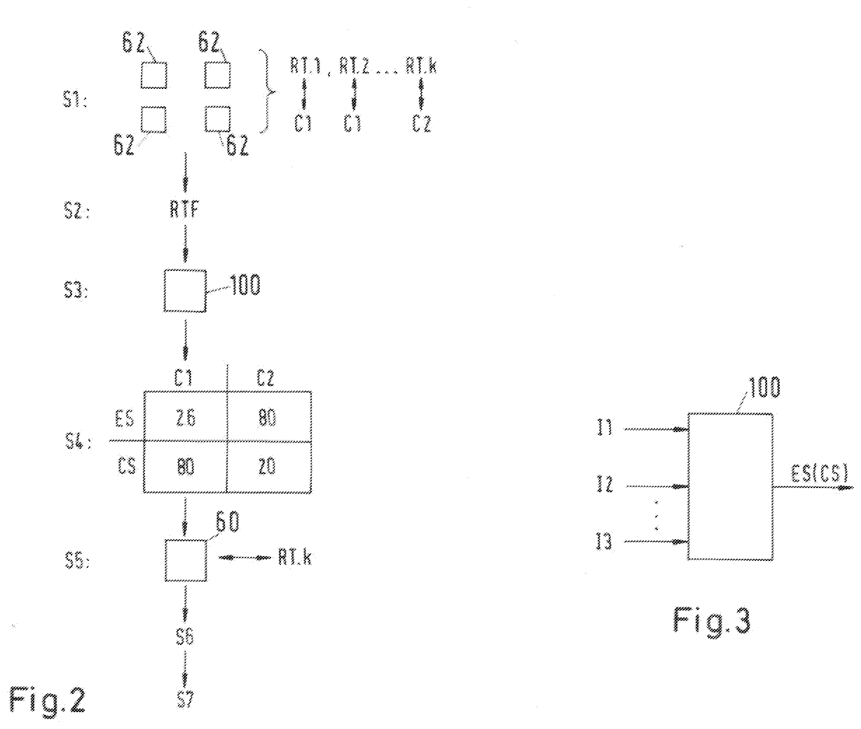

FIG. 2 shows a functional diagram of the computer network of FIG. 1 for explaining the processes and information flow occurring therein; and

FIG. 3 shows a flow diagram of the method performed by the computer network of FIGS. 1 and 2.

FIG. 1 is an overview of a computer network 10 according to an embodiment of the invention, said computer network 10 being generally configured (but not limited) to carrying out the method described in the following. The computer network 10 comprises a plurality of computer devices 12, 21, 20.1-20.k, which are each connected to a communication network 18 comprising several communication links 19.

As will be discussed in the following, the computer devices 20.1-20.k are end devices under direct user control (i.e. are user-bound devices, such as mobile terminal devices and in particular smartphones). The computer device 12 is a server which provides an online platform that is accessible by the user-bound computer devices 20.1-20.k. The computer device 21 provides an analysing capability, in particular with regard to freely-formulated responses provided by a user. However, this capability may also be implemented in the user-bound computer devices 20.1-20.k which could equally comprise a model 100 are discussed below.

In the shown example, the computer network 10 is implemented in an organisation, such as a company, and the users are members of said organisation, e.g. employees. The computer network 10 serves to implement a method discussed below and by means of which evaluations of characteristics of interest with respect to the company can be gathered from the employees. This may be done in form of an online survey conducted with help of a server 12. Specifically, this survey may help to better understand a current state of the company and in particular to identify potentials for improvement based on gathered evaluation information.

In more detail, the computer network 10 comprises a server 12. The server 12 is connected to the plurality of computer devices 20.1-20.k and provides an online platform that is accessible via said computer devices 20.1-20.k. For providing said online platform and in particular the functions and interactions discussed below, the server 12 comprises a data processing unit 23, e.g. comprising at least one microprocessor. The server 12 further comprises data storing means in form of a database system 22 for storing below-discussed data but also program instructions, e.g. for providing the online platform.

Moreover, a so-called analysis part 14 is provided which may also be referred to as a brain to reflect its data analysing capability. Preferably, the analysis part 14 and/or the server 12 are located remotely from the organisation, e.g. in a computational center of a service provider that implements the method disclosed herein.

The analysis part 14 comprises a database 26 (brain database 26) as well as a central computer device 21. The term “central” expresses the relevance of said computer device 21 with regard to the data processing and in particular data analysis.

In general, the computer devices 20.1-20.k are used to interact with the organisation's members and are at least partially provided within the organisation. Specifically, the computer devices 20.1-20.k may be PCs or smartphones, each associated with and/or accessible by an individual member of the organisation. It is, however, also possible that several members share one computer device 20.1-20.k. The central computer device 21, on the other hand, is mainly used for a computer model generation and for analysing in particular a freely formulated response. Accordingly, it may not be directly accessible by the organisation's members but e.g. only by a system administrator.

As noted above, the computer network 16 further comprises a preferably wireless (e.g. electrical and/or digital) communication network 18 to which the computer devices 20.1-20.k, 21 but also the databases 22, 26 are connected. The communication network 18 is made up of a plurality communication links 19 that are indicated by arrows in FIG. 1. Note that such links 19 may also be internally provided within the server 12 and the analysis part 14.

In FIG. 1, one selected computer device 20.1 is specifically illustrated in terms of different functions F1-F3 associated therewith or, more precisely, associated with the online platform that is accessible via said computer device 20.1. Each function F1-F3 may be provided by means of a respective software module or software function of the online platform and may be executed by the processing unit 21 of the server 12 and/or at least partially by a non-illustrated processing unit of the user-bound computer devices 20.1-20.k. The functions F1-F3 form part of a front end with which a user directly interacts.

As will be detailed below, function F1 relates to outputting a free formulation response task to a user, function F2 relates to receiving a freely formulated response from the user in reaction said response task and function F3 relates to outputting an adjusted set of response tasks to the user. A further non-specifically illustrated function is to then receive inputs from the user in reaction to said adjusted set of response tasks.

It is to be understood that any aspects discussed with respect to the computer device 20.1 equally applies to the further computer devices 20.2-20.k. In particular, each further computer device 20.2-20.k provides equivalent functions F1-F3 and enables at least one of the organisation's members to interact with said functions F1-F3. This way, responses can be gathered from a large number of in particular several hundreds of users.

For interacting with a computer device 20.1-20.k and in particular for inputting information, a user may use any suitable input device or input method, such as a keyboard, a mouse, a touchscreen but also voice commands.

Further, a database system 22 of the server 12 is shown. The database system 22 may comprise several databases, which are optimised for providing different functions. For example, in a generally known manner, a so-called live or operational database may be provided that directly interacts with the front end and/or is used for carrying out the functions F1-F3. Also, a so-called data warehouse may be provided which is used for long-term data storage in a preferred format. Data from the life database can be transferred to the data warehouse and vice versa via a so-called ETL-transfer (Extract, Transformation, Load).

The database system 22 is connected to each of the computer devices 20.1-20.k (e.g. via the server 12) as well as to the analysis part 14 and specifically to its brain database 26 via communication links 19 of the electronic communication network 18. As indicated by a respective double arrow in FIG. 1, data may also be transferred back from the analysis part 14 (and in particular from the brain database 26) to the server 12. Said data may e.g. include an adjusted set of predetermined response tasks generated by the central computer device 21.

Note that the functional separation between the server 12 and analysis part 14 in FIG. 1 is only of by way of example. According to this invention, it is equally possible to only provide one of the server 12 and analysis part 14 and implement all functions discussed herein in connection with the server 12 and analysis part 14 into said provided single unit. For example, the central computer device 21 could be designed to provide all respective functions of the server 12 as well.

To begin with, a schematically illustrated initial set of response tasks RT.1, RT.2 . . . RT.K is stored in the brain database 26. Each response task RT.1, RT.2 . . . RT.K may be provided as a dataset or as a software module. The response tasks RT.1, RT.2 . . . RT.K are predetermined with regard to their contents and they are selectable response options 50 and preferably also with regard to their sequence. Each response task RT.1, RT.2 . . . RT.K preferably includes at least two response options 50 of the types exemplified in the general part of this disclosure. The response options 50 are predetermined in that only certain inputs can be made and in particular only certain selections from a predetermined range of theoretically possible inputs our possible.

Due to the initial set of response tasks RT.1, RT.2 . . . RT.K being predetermined in the discussed manner, said response tasks RT.1, RT.2 . . . RT.K and/or the initial set as such may be referred to as being structured. That is, the range of receivable inputs is limited due to the predetermined response options 50, so that a fixed underlying structure or, more generally, a fixed and thus structured expected value range exists.

Note that the brain database 26 also comprises software modules 101-103 by means of which the central computing device 21 can provide the function discussed herein. The software modules are the previously mentioned free-formulation output software module 101, the free-formulation output software module 102 and the response set adjusting software module 103. Any of these modules (alone or in any combination) may equally be provided on a user-level (i.e. may be implemented on the respective user-bound devices 20.1 . . . 20.k).

Furthermore, the brain database 26 comprises a free-formulation response task RTF. Said free-formulation response task RTF is free of predetermined response options 50 or only defines the type of data that can be input and/or the type of input method, such as and input via speech or text. The free-formulation response task RTF prompts a user to provide feedback on a certain topic of interest, said topic being or at least indirectly linked to at least one characteristic to be evaluated.

Both of the free-formulation response task RTF and the initial set of response tasks RT.1, RT.2, RT.k may be exchangeable, e.g. by a system administrator, but not necessarily by the users/employees.

As will be discussed in further detail below, as an initial step, the free-formulation response task RTF is output to a user (function F1) e.g. by transferring said free-formulation response tasks RTF from the brain database 26 to the database system 22 of the server 12. Based on this free formulation response task RTF, a freely formulated (or unstructured) response is received (function F2) and this response is e.g. transferred back from the server 12 to the brain database 26. Following that, the central computer 21 performs an analysis of the freely formulated response with help of a computer model 100 (also referred to as model 100 in the following) stored in the brain database 26 and discussed in further detail below.

Based on the analysis result, an adjusted set 60 of response tasks RT.1 . . . RT.K is generated, again preferably by the central computer device 21 and preferably stored in the brain database 26. In the shown example, this adjustment takes place by removing at least some of the response tasks from the initial set (cf. the response task RT.2 of the initial set not being included in the adjusted set 60). Additionally, the number of response options 50 may be changed and/or different response options 52 may be provided (see response options 50, 52 of response task RT.k of the initial set compared to the adjusted set 60).

The adjusted set 60 is then again transferred to the server 12 and output to the users according to function F3. Following that, evaluation information are gathered from the users which answer the response tasks RT.1 . . . RT.k of this adjusted set 60. These evaluation information may be transferred to the brain database 26 and further processed by the computing device 21, e.g. to derive an overall evaluation result and/or to compute the completeness score discussed below.

FIG. 2 shows a flow diagram of a method that may be carried out by the computer network 10 of FIG. 1. The following discussion may in part focus on an interaction with only one user. Yet, it is apparent that a large number of users are considered via their respective computer devices 20.1-20.k. Each user may thus perform the following interactions and this may be done in an asynchronous manner, e.g. whenever a user finds the time to access the online platform of the server 12.

As a general aspect, it is shown that the initial set of response tasks RT.1, RT.2, RT.k is subdivided into a number of subsets or modules 62. As noted below, the modules 62 can further be subdivided into topics by grouping response tasks RT.1, RT.2, RT.k included therein according to certain topics. In a step S1, this overall initial set is received, e.g. by being defined by a system administrator and/or by generally being read out from the system database 26 and preferably being transferred to the server 12.

Each response task RT.1, RT.2, RT.k is associated with at least one characteristic C1, C2 for which evaluation information shall be gathered by the responses provided to said response tasks RT.1, RT.2, RT.k. The evaluation information may be equivalent to and/or may be based on response options 50, 52 selected by a user when faced with a response task RT.1, RT.2, RT.k.

Note that in the shown example, different response tasks RT.1, RT.2 may be used for evaluating the same characteristic C1. This is, for example, the case when a number of evaluation information and in particular evaluation scores are to be gathered for evaluating the same characteristic C1 and, in particular, for deriving a statistically significant and reliable evaluation of said characteristic C1.

In the shown example, the characteristics C1, C2 may relate to predetermined aspects which have been identified as potentially improving the organisation's performance or potentially acting as obstacles to achieving a sufficient performance (e.g. if not being fulfilled). The characteristics C1, C2 may also be referred to or represent mindsets and/or behaviors existing within the organisation's culture. By way of the evaluation information gathered by each response task RT.1, RT.2, RT.k and from each user, evaluation scores may be computed as discussed in the following which e.g. indicate whether a respective characteristic C1, C2 is perceived to be sufficiently present (positive and/or high score) or is perceived to be insufficiently present (negative and/or low score).

In a step S2 the free-formulation response task RTF is received and in a similar manner. Following that, it is output to a user whenever he accesses the online platform provided by the server 12 to conduct an online survey. The user is thus prompted to provide a freely formulated response.

As an optional measure which is not specifically indicated in FIG. 2, an initial step (e.g. a non-illustrated step S0) can be provided in which a common understanding in preparation of the free-formulation response task RTF is established. This may also be referred to as an anchoring of e.g. the user with regard to said response task RTF and/or the topic or characteristic C1, C2 concerned. Specifically, text information, video information and/or audio information for establishing a common understanding of a topic on which feedback shall be provided by means of the pre-formulation response task RTF may be output to the user. In the shown example, this may be a definition of the term “performance” and what the performance of an organisation is about.

Following that, as a general example, the free-formulation response task RTF may ask the user to provide his opinion on what measure should best be implemented, so that the organisation can improve its performance. The user may then response e.g. by speech which is converted into text by any of the computer devices 20.1, 20.2, 20.K, 12, 21 of FIG. 1. This response may e.g. be as follows “I want disruptors, start up and innovators who can bring new thinking into the organisation. If we want to continue success and growth strategy we need people to challenge the status quo”.

In a step S3, the converted text (which is equally considered to represent the freely formulated response herein, even though said response might have originally been input by speech) is analysed with help of the model 100 indicated in FIG. 1.

The model 100 determines evaluation information contained in the freely formulated response. Specifically, the model 100 is a computer model generated by machine learning and, in the shown case, is an artificial neural network. It analyses the freely formulated response with regard to which words are used therein and in particular in which combinations. Such information are provided at an input side of the model 100. At an output side, evaluation scores for the characteristics C1, C2 are output, said scores been derived from the freely formulated response. Possible inner workings and designs of this model 100 (i.e. how the information at the input side are linked to the output side) are discussed in the general specification and are further elaborated upon below.

In a step S4, the central computing device 21 checks for which characteristics C1, C2 (the total number of which may be arbitrary) evaluation scores have already been gathered. This is indicated in FIG. 2 by a table with random evaluation scores ES from an absolute range of zero (low) to 100 (high) for the exemplary characteristics C1, C2.

Likewise, confidence scores CS are determined for each characteristic C1, C2. These indicate a level of confidence with regard to the determined evaluation score ES, e.g. whether this evaluation score ES is actually representative and/or statistically significant. They thus express a subjective certainty and/or accuracy of the model 100 with regard to the evaluation score ES determined thereby. These confidence scores CS may equally be computed by the model 100 e.g. due to being trained based on historic data as discussed above.

It is then determined, for which characteristics C1, C2 evaluation information in form of the evaluation scores ES have already been provided and in particular whether these evaluation information have sufficiently high confidence scores CS. This is done in step S5 to generate the adjusted set 60 of response tasks RT.1, RT.k based on the criteria discussed so far and further elaborated upon below.

For example, it may be determined that the evaluation score ES for the characteristics C1 of FIG. 2 is rather low (which is generally not a problem), but that the confidence score CS is rather high (80 out of 100). If the confidence score CS is above a predetermined threshold (of e.g. 75), it may be determined that sufficient evaluation information have already been provided for the associated characteristic C1. Thus, the response tasks RT.1, RT.2 that are designed to gather evaluation information for said characteristic C1 may not be part of the adjusted set 60. Instead, said set 60 may only comprise the response task RT.k since the characteristics C2 associated therewith is marked by a rather low confidence score CS.

Differently put, from the freely formulated response, only insufficient evaluation information could be identified for the characteristics C2. Thus, the user should be confronted with the response task RT.k that is specifically directed to gathering evaluation information for this characteristic C2 in the final step S6.

Note that as a general aspect of this invention which is not bound to the further details of the embodiments, adjusting the set of response task may be performed on a user-level (i.e. each user receiving an individually adjusted set of response task based on his freely formulated response).

In step S6, the adjusted set of response tasks is output to the user which then performs a standard procedure of answering the response tasks of said set by selecting response options 50, 52 included therein. This way, further evaluation scores are gathered for at least remaining insufficiently evaluated characteristics of interest. Updating the evaluation scores ES but also possibly the confidence scores CS for said characteristic C1, C2 based on the responses to the adjusted set 60 is preferably done by the central computer device 21. The survey may be finished when all response tasks of the adjusted set 60 have been answered. Yet, the method may then continue to determine a completeness score discussed below by considering evaluation information across a plurality of and in particular all users.

Note that in particular steps S5 and step S6 have only been described with reference to one user. It is generally preferred to consider responses gathered from a plurality of users in a concurrent or asynchronous manner in these steps S5, S6.

As a further optional feature, a completeness score may be computed. This is preferably done in a step S7 and based on the users' answers to the adjusted sets 60 of response tasks RT.1, RT.2, RT.k. Accordingly, the completeness score is preferably determined based on evaluation information gathered from a number of users.

The completeness score may be associated with a certain module 62 (i.e. each module 62 being marked by an individual completeness score). It may indicate a level of completeness of the evaluation information gathered so far with regard to whether these evaluation information are sufficient to evaluate each characteristic C1, C2 associated with said modules 62 (and/or with the response tasks RT.1, RT.2, RT.k contained in said module 62).

Additionally or alternatively, it may indicate or be determined based on a level of statistical certainty and/or confidence with regard to the evaluation score ES determined for a characteristic C1, C2. For example, the distribution of evaluation scores ES across all users determined for a certain characteristic C1, C2 may be considered and a standard deviation thereof may be computed. If this is above an acceptable threshold, it may be determined that an overall and e.g. average evaluation score ES for said characteristic C1, C2 has not been determined with a sufficient statistical confidence in this may be reflected by a respective (low) value of the completeness score.

Overall, the completeness score for each module and//or each characteristic may be used to determine any of the following (alone or in any combination):
What to ask a respondent, e.g. as the free formulation response task (preferably directed to a module with a so far insufficiently low completeness score);
What should be a next module for the current respondent (preferably a module with a so far insufficiently low completeness score);
If any further response tasks directed to a certain module should be output to a current respondent, e.g. in case said module is not yet marked by a sufficiently high completeness score;
If any further respondents are needed, e.g. should be involved and contacted for completing the online survey, for example in case at least one module has a completeness score below of an acceptable threshold.

Note that as a general aspect of this invention, which is not limited to any further details of the embodiments, the modules 62 may also be subdivided into topics. The response tasks of a module 62 may accordingly be associated with these topics (i.e. groups of response tasks RT.1, RT.2, RT.k may be formed which are associated with certain topics). A completeness score may then also be determined based on a respective topic-level. In case it is determined, that for a certain topic and across a large population of users a low completeness score is present, any of the above measures may be employed.

FIG. 3 is a schematic view of the model 100. Said model 100 receives several input parameters I1 . . . I3. These may represent any of the examples discussed herein and e.g. may be derived from a first analysis of the contents of the freely formulated response. For example, the input parameter I1 may indicate whether one or more (and/or which) predetermined keywords have been identified in said response. The input parameter I2 may indicate a generally determined negative or positive connotation of the response and the input parameter I3 may be an output of a so-called Word2Vec algorithm. These inputs may be used by the model 100, which has been previously trained based on verified training data, to compute the evaluation score ES and preferably a vector of evaluation scores for a number of predetermined characteristics of interest. Also, it may output confidence scores CS for each of the determined evaluation scores ES.

Note that the freely formulated response (e.g. as a text) may, additionally or alternatively, also be input as an input parameter to the model 100 as such. The model 100 may then include sub-models or sub-algorithms to determine any of the more detailed input parameters I1 . . . I3 discussed above or the model may directly use each single word of the freely formulated response as a single input parameter (e.g. an input vector may be determined indicating these words from a predetermined list of words (e.g. dictionary) that are contained in the response). Again, based on the previous training with verified training data, the model 100 may then determine evaluation scores associated with certain words and/or combinations of words occurring within one freely formulated response RTF.

Note that an adjusted set of response tasks RT.1, RT.2, RT.k may entail that the contents of the module 62 is respectively adjusted, i.e. that certain response tasks RT.1, RT.2, RT.k are deleted therefrom.

After a user has completed answering a module 62, it may be determined by a dialogue-algorithm which module 62 should be covered next. Additionally or alternatively, it may be determined which response task RT.1, RT.2, RT.k or which topic of a module 62 should be covered next. Again, only those response tasks RT.1, RT.2, RT.k comprised by the adjusted set may be considered in this context.

The dialogue algorithm may be run on the server 12 or central computer device 21 or on any of the user bound devices 20.1-20.k. As a basis for its decisions, a completeness score or a confidence score as discussed above and/or a variability any of the scores determined so far may be considered. Additionally or alternatively, a logical sequence may be prestored according to which the module 62, topics or response tasks RT.1, RT.2, RT.k should be output. Generally speaking, decision rules may be encompassed by the dialogue algorithm.

Providing the dialogue algorithm helps to improve the quality of responses since users may be faced with sequences of related response tasks RT.1, RT.2, RT.k and topics. This helps to prevent distractions or a lowering of the motivation which could occur in reaction to random jumps between response tasks RT.1, RT.2, RT.k and topics. Also, this helps to increase the level of automation as well as speeds up the whole process, thereby limiting occupation time and resource usage of the computer network 10.

1-13. (canceled)

14. A method for generating an adjusted set of response tasks based on a freely formulated response of a user with a computer network, the method comprising using the computer network to perform the following steps:
receiving an initial set of predetermined response tasks, each response task including a number of predetermined response options, and determining evaluation information for evaluating at least one predetermined characteristic based on the response options selected by a user;
using a computer device of the computer network to output at least one free-formulation response task to at least one user, with which an at least partially freely formulated response can be received from the user;
using a computer device of the computer network configured to analyze the at least partially freely formulated response to identify evaluation information based on the freely formulated response, the evaluation information being usable for evaluating the at least one predetermined characteristic; and
using a computer device of the computer network to generate an adjusted set of response tasks based on the identified evaluation information and to output the adjusted set of response tasks to the user.

15. The method according to claim 14, which further comprises:
at least partially basing the freely formulated response on one of:
a text response;
a speech response; or
behavioral characteristics of a respondent.

16. The method according to claim 14, which further comprises:
using the free-formulated response task to ask the user to provide feedback on a certain topic.

17. The method according to claim 14, which further comprises:
carrying out the step of generating the adjusted set of predetermined response tasks by:
reducing a number of at least one of the response tasks or response options within the initial set of predetermined response tasks.

18. The method according to claim 17, which further comprises:
removing at least one of those response tasks or response options being provided to gather evaluation information having already been identified based on the freely formulated response.

19. The method according to claim 14, which further comprises:
carrying out the step of generating the adjusted set of predetermined response tasks by:
selecting certain of the response tasks from the initial set of predetermined response tasks, the selected response tasks making up the adjusted set of predetermined response tasks.

20. The method according to claim 14, which further comprises:
performing the identification of evaluation information based on the freely formulated response by using a computer model having been generated based on machine learning.

21. The method according to claim 20, which further comprises:
using the computer model to at least one of determine or define a relation between contents of the freely formulated response and evaluation information for the at least one characteristic.

22. The method according to claim 20, which further comprises:
using the computer model to compute an evaluation score indicating how the characteristic is evaluated.

23. The method according to claim 22, which further comprises:
using the computer model to compute a confidence score indicating a confidence level of the computed evaluation score.

24. The method according to claim 14, wherein the computer model at least one of includes or is generated based on an artificial neural network.

25. The method according to claim 14, which further comprises:
computing a completeness score indicating a level of completeness of the gathered evaluation information based on responses received from a plurality of users.

26. A computer network configured to generate an adjusted set of response tasks based on a freely formulated response of a user, the computer network comprising:
an initial set of predetermined response tasks, each response task including a number of predetermined response options, for determining evaluation information for evaluating at least one predetermined characteristic based on the response options selected by a user;
a data storage unit;
at least one processing unit configured to execute any of the following software modules stored in said data storage unit:
a free-formulation output software module configured to provide at least one free-formulation response task with which a freely formulated response can be received from at least one user;
a free-formulation analysis software module configured to analyze the freely formulated response and to thereby identify evaluation information contained therein, the evaluation information being usable for evaluating the at least one predetermined characteristic;
a response set adjusting software module configured to generate an adjusted set of response tasks based on the evaluation information identified by said free-formulation analysis software module; and
at least one output device configured to output the adjusted set of response tasks to the user.

27. A method for generating an adjusted set of response tasks based on a freely formulated response of a user with a computer network, the method comprising using the computer network to perform the following steps:
receiving an initial set of predetermined response tasks, each response task including a number of predetermined response options, and determining evaluation information for evaluating at least one predetermined characteristic based on the response options selected by a user;
using a computer device of the computer network to output at least one free-formulation response task to at least one user, and to receive an at least partially freely formulated response from the user;
using a computer device of the computer network configured by a model or algorithm to analyze unstructured data of the at least partially freely formulated response to identify evaluation information based on the freely formulated response, the evaluation information being used for evaluating the at least one predetermined characteristic; and
using a computer device of the computer network to generate an adjusted set of response tasks based on the identified evaluation information and to output the adjusted set of response tasks to the user.
